(19) United States
(12) Patent Application Publication
(10) Pub. No.: US 2016/0201854 A1
(43) Pub. Date: Jul. 14, 2016

(54) DEVICE AND METHOD FOR INDICATING A FILL LEVEL OF A SORPTION STORE

(71) Applicant: BASF SE, Ludwigshafen (DE)

(72) Inventors: Matthias WEICKERT, Ludwigshafen (DE); Stefan MARX, Dirmstein (DE); Ulrich MÜLLER, Neustadt (DE); Peter RENZE, Mannheim (DE)

(21) Appl. No.: 14/911,789

(22) PCT Filed: Aug. 11, 2014
(86) PCT No.: PCT/IB2014/063841

§ 371 Date: Feb. 12, 2016

(30) Foreign Application Priority Data
Aug. 15, 2013 (EP) 13180521.0

(51) Int. Cl. F17C 11/00

(52) U.S. Cl. CPC F17C 11/007; F17C 2250/0408; F17C 2250/043; F17C 2250/0439; F17C 2250/03

(57) ABSTRACT

A process for indicating a fill level of a sorption store (1), wherein at least one gas adsorbent medium (5) is disposed within at least one vessel (3) and wherein a total amount (nₜₒₜₐₗ) of a gas (15) stored in the sorption store (1) is computed based on at least one measured temperature value and at least one measured pressure value.

The present invention relates to a process for indicating a fill level of a sorption store, wherein said fill level is computed from at least one measured temperature value and at least one measured pressure value. The invention further relates to a device for effectuating the process according to the invention. A total amount of gas stored in the sorption store is computed based on an empirical model or in at least two steps for indicating the fill level. In a first step comprising a first model, an amount of gas present in a gas phase is computed based on a thermodynamic equation of state and in a second step, comprising a second model, an amount of gas adsorbed by an at least one gas adsorbent medium disposed in the sorption store is computed based on the adsorption equilibrium, which is described for example by the Dubinin-Astakhov equation.

Owing to the increasing scarcity of oil resources, research is increasingly being made to unconventional fuels such as methane, ethanol or hydrogen for operating an internal combustion engine or a fuel cell. For this purpose, vehicles comprise a storage vessel for keeping a stock of the fuel. For the storage of gas in stationary and mobile applications, the gas is stored in pressure vessels, often referred to as compressed natural gas (CNG) technique or in sorption stores, often referred to as adsorbed natural gas (ANG) technique. Sorption stores are also known as ANG tanks.

ANG has the potential to replace compressed natural gas CNG in mobile storage applications such as in vehicles. Although a substantial research effort has been devoted to ANG, very few studies evaluate the impact of heat of adsorption on system performance. In turn, in ANG-applications a micro powder solid, such as activated carbon, is packed in a vessel to increase the storage density, enabling lower pressure operation with the same capacity. Adsorption is an exothermic process. Any adsorption or desorption is accompanied by a temperature change in an ANG-storage system. The heat of adsorption has a detrimental effect on performance during both filling- and discharge cycles. A temperature increase as high as 80° C. can occur during the filling cycle. A filling cycle normally will be performed in a fuel station, at least for mobile applications, where the released adsorption heat can be removed. Contrary to the filling cycle, the rate of discharge is dictated by the energy demand of the application. The filling time cannot be widely varied to moderate the impact of cooling during the use of ANG storage vessels.

Sorption stores comprise in particular adsorbent media having a large internal surface area on which the gas is adsorbed. The gas is stored by the adsorption on the adsorbent medium, in the cavities between the individual particles of the adsorbent medium and in parts of the vessel, which are not filled with adsorbent medium. The filled sorption store can be operated pressurized and non-pressurized. The selection of a suitable vessel depends on the applied maximum pressure. The higher the storage pressure, the more gas can be stored per volume.

Adsorption describes the attachment of atoms or molecules of a gaseous or liquid fluid onto the surface of a solid material, which is referred to as adsorbent medium for the purpose of the present invention. Terms like adsorbent, adsorber and adsorption medium are equally known for the denomination of the said solid material. The adsorption capacity of the adsorbent media, defined by the ratio of the mass of the adsorbed gas or liquid to the mass of the adsorbent medium, strongly depends on temperature and is reduced with increasing temperature. In the aim of a maximal exploitation of the storage space, the temperature profile established in the adsorbent media during the filling procedure has to be taken into consideration. Furthermore, an efficient adsorption allows a reduced filling time as the same amount of gas can be stored in a shorter time period. Hence, the maximum amount of stored gas can be increased when the available filling time is limited. During filling the sorption store with gas two sources are relevant for a temperature increase in the vessel. These are the heat due to the compression of the gas and the heat liberated as a result of the exothermic adsorption. The generated heat directly depends on the amount of adsorbed gas. The more gas is adsorbed on the adsorbent medium, the more heat is liberated. And with increasing adsorbed amount of gas on the adsorbent medium, the adsorption rate, defined as amount of gas adsorbed per unit of time, is reduced.

Besides, desorption is an endothermic process and heat has to be supplied when gas is taken from the store. Heat management is therefore of great importance when sorption stores are used.

A crucial aspect for sorption stores in mobile applications is the limited space available for example on vehicles. Therefore, a high energy density in the sorption store is pursued in order to maximize the range a vehicle can cover with only one fill-up. Due to the limited space it is not feasible to include excessive hard ware to moderate the temperature in a mobile application.

US 2007/180998 A1 is related to an apparatus for optimal adsorption and desorption of gases utilizing high porous gas storage materials. An apparatus for separately adsorbing gas during adsorption processes and desorbing gas during sorption processes is disclosed. A tube is equipped with a porous sidewall and at each end an end-fitting sealingly connected is connected thereto. A particulate porous gas storage material is located within the tube, wherein the porosity prevents the material, but allows gases to pass therethrough. A selected gas from a porous tube, a heating coil or a heat exchanger located within the tube may provide heat for the desorption processes and the selected gas or heat exchanger may provide cooling during the adsorption processes.

US 2008/0290645 A1 is related to shaped adsorbent media installed in a high-pressure tank. An adsorbent medium suitable for gas or heat is provided in the predetermined lengths or is provided in a pre-determined length of a polygon or a curvilinear, and preferably a honeycomb (hexagonal) cross-sectioned shape with gas adsorbent media packed therein. The hexagonal tubes may be installed along the radial or longitudinal axis of a fuel tank. The media and/or media tubes are installed during tank manufacture and include defined physical and gas circulation relationships for maintaining extending tubes having a gas adsorbent medium therein in a predetermined interrelationship with adjacent spaces of similar shape that are either open or filled with a heat adsorbent medium.

WO 2009/071436 A1 is related to a method for storing gaseous hydrocarbons. Gaseous hydrocarbons are stored in a sorption reservoir. The temperature of the stored hydrocarbons when the sorption reservoir is full, is lower than room temperature and higher than the evaporation temperature of the hydrocarbon. This solution also relates to a device for storing gaseous hydrocarbons, comprising a sorption reservoir that is isolated in relation to the surroundings. The sorption reservoir contains zeolite, activated carbons, or metal-organic framework compounds.

US 2009/0261107 A1 is related to a motor vehicle with a gas tank. The vehicle is powered by a fuel cell system and/or an internal combusted engine, and having at least one gas tank for being filled with a gaseous fuel, in particular with natural gas or hydrogen, wherein a metal-organic framework (MOF) is arranged in the interior of the gas tank as a storage material for holding the fuel is disclosed. A comparatively high storage density is obtained and/or sufficient space for luggage or loading is made available within the vehicle. This is achieved according to US 2009/0261107 A1 in that the gas tank which comprises the metal organic framework (MOF) is embodied as a compressed gas tank for storing the gaseous fuel under pressure.

US 2012/0308944 A1 discloses a method of manufacturing a perforated pipe for a gas generator as well as a gas generator. A method for manufacturing a perforated pipe for a gas generator is disclosed including a pipe-like member forming step of forming a closed-bottom pipe-like member from a plate-like member by press-forming using a rod-like member and a mold. A hole punching step follows inserting a die into the pipe-like member in place of the rod-like member, the die including one or more through holes in a direction intersecting an axial direction thereof and punching through the pipe-like member formed in the pipe-like member forming step with a punching member aligned with the position of each through hole to form one or more pairs of opposed punch holes. A distance between the paired punch holes is any value selected from 3 mm to 10 mm, respectively.

U.S. Pat. No. 7,059,364 discloses a method for the quick filling of a vehicle storage vessel with hydrogen. The empty vessel is filled stepwise until a pressure of more than 6000 pfig is reached.

U.S. Pat. No. 5,771,948 describes a method and an apparatus for dispensing natural gas into a natural gas vehicle cylinder of a motor vehicle. The filling process for compressed natural gas (CNG) is addressed. The system is equipped with pressure sensors, temperature sensors and a mass flow meter in order to maximize the amount of gas injectable into the cylinder.

US 2005/0178463 discloses a method for quick filling a vehicle storage vessel with hydrogen according to the conventional compressed natural gas (CNG) technique. The disclosed method and system compensate the temperature increase in the vessel during filling. The filling with gas is conducted stepwise according to a particular algorithm.

WO 2013/086345 describes systems and methods for monitoring a fuel level of a vehicle. Natural gas is stored in a compressed gas tank. An electronic control determining the gauge command based on measured signals and a filling compensation scheme is addressed.

DE 10 2009 030 155 discloses a non-pressurized storage for hydrogen on the basis of nanostructured carbon and metal organic framework material (MOF). The amount of stored hydrogen is quantified internally in the cartridge by means of magic angle spinning nuclear resonance (MAS-NMR) spectroscopy.

Xiao et al. in “Lumped parameter simulation for charge-discharge cycle of cryo-adsorptive hydrogen storage system”, International Journal of Hydrogen Energy, Vol. 37 (2012) 13400-13408, apply a modified Dubinin-Astakhov equation to model adsorption isotherms in the aim to predict the pressure and the average temperature variation in a storage tank for a charge-discharge cycle of the cryo-adsorption of hydrogen. The lumped parameter simulation is based on Matlab/Simulink and further considers a variational isosteric heat of adsorption. The results optained by Simulink are compared to experimental results and to two-dimensional simulation results by Comsol. The effect of the charge flow rate on the performance, especially on the temperature peak value, is studied.

Xiao et al. in “CFD simulation for charge-discharge cycle of cryo-adsorptive hydrogen storage on activated carbon”, International Journal of Hydrogen Energy, Vol. 37 (2012) 12893-12904, apply the computational fluid dynamics (CFD) software FLUENTTM to model the hydrogen adsorption process for the charging and discharging of a storage vessel. The adsorption equilibrium is described by a modified Dubinin-Astakhov equation. Further, the kinetics of the hydrogen adsorption is expressed by a linear driving force (LDF) model. A constant isosteric heat of adsorption is assumed in this study and an effect of the heat capacity of adsorbed hydrogen on the effective heat capacity is considered. The CFD model is based on the mass, momentum and energy conservation equations of a system formed of gaseous and adsorbed hydrogen. The CFD software FLUENTTM is further based on the finite control volume (FCV) method. The simulated results are compared to measured temperature values.

Mu et al. in “Adsorption equilibrium of methane and carbon dioxide on porous metal-organic framework Zn-BTB”, Adsorption, Vol. 17 (2011) 777-782, model the adsorption equilibrium of methane and carbon dioxide on a metal organic framework material applying the Toth equation and the Dubinin-Astakhov equation. The model results are compared to data obtained by measurement of single-component adsorption isotherms in a high-pressure gravimetric adsorption apparatus.

The indication of a fill level, which represents the amount of gas currently stored in the sorption store, is well known for a vessel containing mere compressed gas. The determination of a total amount of gas currently stored in a gas store is complex in the case where an amount of adsorbed gas has to be taken into account. Gas molecules adsorbed on the surface of a solid adsorbent medium are not directly accessible by common sensors and the amount of adsorbed gas depends on various parameter like pressure, temperature, properties of the gas and properties of the adsorbent medium to mention but a few. Therefore, a technically applicable mean is needed for the quantification of the amount of adsorbed gas in a sorption store. Models describing the relationship between the amount of adsorbed gas and parameters characterizing the surrounding of the adsorbent medium are applied in literature for the simulation and optimization of the charge and discharge process of sorption stores, i.e. the prediction of pressure, flow and temperature profiles.

It is an objective of the present invention to provide a process and a device for indicating a fill level of a sorption store, wherein a total amount of gas stored in the sorption store is computed from at least one measured temperature value and at least one measured pressure value, which are obtained in the sorption store by sensors.

### SUMMARY OF THE INVENTION

In order to indicate a fill level of a sorption store for example to a driver of a vehicle during the drive or the charge process at a filling station, the current temperature and the current pressure are measured in or at the vessel of the sorption store. In a first step, the at least one measured temperature value and the at least one measured pressure value are used to compute an amount of a gas present in a gas phase in the interior of the sorption store. Based on the current amount of gas present in the gas phase, a current amount of gas adsorbed by an at least one gas adsorbent medium can be computed in a second step. A current total amount of gas stored in the sorption store, which is then indicated as the fill level, is obtained by summing up the current amount of gas present in the gas phase and the current amount of gas adsorbed by the at least one gas adsorbent medium.

### Preferred Embodiments

For the purposes of the invention, sorption stores are stores which comprise an adsorbent medium having a large surface area in order to adsorb gas and thereby store it. Sorption stores can store gas by both means of adsorption and means of compression of gas. Thus, heat is liberated during filling of the sorption store, while the desorption is activated by introduction of heat.

In the embodiment according to the invention a fill level of a sorption store is indicated by a process, wherein at least one gas adsorbent medium is disposed within at least one vessel and wherein a total amount of a gas stored in the sorption store is computed based on at least one measured temperature value and at least one measured pressure value.

In a preferred embodiment the process comprises at least two steps, wherein an amount of gas present in a gas phase is computed in a first step and an amount of gas adsorbed by the at least one gas adsorbent medium is computed in a second step and wherein the total amount of gas stored in the sorption store is the sum of the amounts of gas calculated in the at least two steps.

In an alternative to the two step process, the indication of the fill level can be directly deduced from the at least one measured temperature value and the at least one measured pressure value based on a completely empirical model in a further preferred embodiment. For this purpose experimental data are empirically fitted to an empirical model defining the relation between the total amount of gas stored in the sorption store and the at least one measured temperature value and the at least one measured pressure value. The empirical model is at least specific to the gas, the adsorbent medium and the packing density.

An advantage of the process, wherein the amount of gas is calculated in the at least two steps compared to the empirical model is, that no further experiments are necessary in case the packing density, the gas or the adsorbent medium are changed. Further, the amount of gas adsorbed by the at least one gas adsorbent medium is known and the heat required for a desorption of the remaining adsorbed gas can be calculated during the drive. Moreover, the temperature increase during the filling process can be predicted and a maximum dosage can be determined in order to prevent an overheating of the surfacewall of the vessel.

The total amount of gas stored in the sorption store and indicated as a fill level of the sorption store comprises firstly an amount of gas present in the gas phase and secondly, the amount of gas adsorbed by the at least one gas adsorbent medium. In a first step, the amount of gas present in the gas phase is determined from at least one measured temperature value and at least one measured pressure value. In a preferred embodiment, data known from the sorption store as a basis of the calculation include the total volume of the interior of the sorption store, the volume occupied by the solid material of the gas adsorbent medium, also referred to as skeleton volume, the molecular weight of the gas to be adsorbed, the specific surface of the gas adsorbent medium, the adsorption enthalpy of the gas adsorbent media with respect to the gas to be adsorbed, the bulk density, the adsorbed amount of gas in dependency on pressure and temperature, the real gas behavior of the gas in the gas phase, e.g. methane, in regard to pressure and temperature and the weight of adsorbent medium disposed in the vessel.

In a preferred embodiment at least one pressure sensor and at least one temperature sensor are disposed in the interior of the sorption store. Sensors commonly used in the art and known for example from the CNG technique can be used for this purpose. The position of the at least one pressure sensor can be freely selected in the interior of the vessel or at the inlet of the vessel as the pressure is equally distributed in the system.

In a preferred embodiment, the at least one temperature sensor is disposed in the vessel in a position characterized by a temperature from which the average temperature of the interior of the sorption store is deducable.

In a further preferred embodiment, the process and device for indicating a fill level according to the invention is reliable during the charge and the discharge process of the sorption store. The charge and the discharge process of a sorption store are commonly deferring in the feed and discharge rate. The feed rate is superior to the discharge rate, as the filling process at the filling station is effectuated in an accelerated manner as time saving is crucial for the filling process.

The discharge process is slow compared to the filling process as the discharge is generally due to the gas consumption, for example during the drive of a vehicle. In case of a slow discharge of the sorption store, the temperature can be assumed to be equally distributed in the system and the position of the at least one temperature sensor can be freely selected in the sorption store. However, the fast filling of the sorption store, including a compression of gas and a simultaneous adsorption process, leads to an inhomogeneous temperature distribution in the interior of the sorption store and especially in the gas adsorbent medium. Consequently, the position of the at least one temperature sensor is carefully selected in a preferred embodiment. In particular preferred is a position, where the temperature is representative for or related to the current average temperature in the sorption store. In case of a substantially horizontally mounted vessel a position of the at least one temperature sensor is preferred, which is located centrally with regard to the vertical extension of the vessel and centrally or further away from the inlet with regard to the horizontal extension of the vessel. In case of a substantially vertically mounted vessel a position of the at least one temperature sensor is preferred, which is located centrally with regard to the horizontal extension of the vessel and with regard to the vertical extension of the vessel. In the aim of an easy assembly, a position of the at least one temperature sensor close to the inlet is preferred in both cases, of a substantially horizontally mounted vessel and of a substantially vertically mounted vessel. Here, the at least one temperature sensor is preferably shifted to one side of the inlet in order to avoid an interfered filling process.

In order to optimize the estimation of the current average temperature in the sorption store, more than one temperature sensor can be used, wherein the temperature sensors are mounted in the vessel at positions which deviate from each other in temperatures during the filling process. A calculation of a current average temperature can then be based on the data obtained by the more than one temperature sensor.

Any type of temperature sensor or pressure sensor can be applied to determine the current temperature and pressure in the interior of the sorption store. Pressure sensors can be of a piezoresistive, capacitive, electromagnetic, piezoelectric, optical or potentiometric typ, to mention but a few. For temperature sensors, thermocouples, resistant thermometers or others can be used.

In a preferred embodiment, the first step comprises a first model describing an amount of gas present in a gas phase in dependency of the at least one measured temperature value and the at least one measured pressure value.

In a particularly preferred embodiment the first model comprises a thermodynamic equation of state selected from a group comprising the ideal gas law, the Van der Waals equation of state, the Redlich-Kwong equation of state, the Peng-Robinson equitation of state or modifications thereof.

In an embodiment, the amount of gas present in the gas phase is calculated from the at least one measured temperature value and the at least one measured pressure value by a first model based on a thermodynamic equation of state. Any known empirical or theoretical equation of state can be applied, which describes the relation between an amount or concentration of gas and temperature and pressure. In a preferred embodiment, the first model comprises the ideal gas law:

p*V=n*R*T,

where p is the pressure, V the volume, n the amount of substance, R the ideal gas constant with R=8.3144621 J*mol⁻¹*K⁻¹ and T the temperature. Alternatively, the first model can comprise other thermodynamic equations of states, such as for example the Van-der-Waals equation, the Clausius equation, the Redlich-Kwong equation and the Peng-Robinson equation, which are well known in the art and literature. Further, modifications thereof are equally applicable.

In a particularly preferred embodiment, the first model is based on a real gas law for methane according to Setzmann et al., in “A New Equation of State and Tables of Thermodynamic Properties for Methane Covering the Range from the Melting Line to 625 K at Pressures up to 1000 MPa”, Journal of Physical and Chemical Reference Data, Vol. 20 (1991) 1061-1155. Here, the real gas law for methane is expressed with the dimensionless Helmholtz energy φ=A_{H}/(RT):

$${A}_{H} ( δ , τ ) / ( RT ) = φ ( δ , τ ) = {φ}^{0} ( δ , τ ) + {φ}^{r} ( δ , τ ) , with$$

$$δ = ρ / {ρ}_{c} and τ = {T}_{c} / T , and with$$

$${φ}^{0} = ( δ , τ ) = ln ( δ ) + {a}_{1} + {a}_{2 τ} + {a}_{3} ln ( τ ) + {\sum }_{i = 4}^{8} {a}_{i} ln ( 1 - {e}^{- {θ}_{i}^{c} τ} ) and$$

$${φ}^{r} ( δ , τ ) = {\sum }_{i = 1}^{13} {n}_{i} {δ}^{{d}_{i}} {τ}^{{t}_{i}} + {\sum }_{i = 14}^{36} {n}_{i} {δ}^{{d}_{i}} {τ}^{{t}_{i}} {e}^{- δ {c}_{i}} + {\sum }_{i = 37}^{40} {n}_{i} {δ}^{{d}_{i}} {τ}^{{t}_{i}} {e}^{- {{α}_{i} ( δ - {Δ}_{i} )}^{2} - {{β}_{i} ( τ - {γ}_{i} )}^{2}} ,$$

where A_{H} is the specific Helmholtz energy, R is the ideal gas constant, T is the temperature, δ is the reduced density, ρ is the mass density, ρ_{c}=162.66 kg/m³ is the critical density, τ is the inverse reduced temperature, T_{c}=190.564 K is the critical temperature, φ⁰ is the ideal part of the Helmholtz function, φ^{r} is the residual part of the Helmholtz function and a, c, d, t, α, β, γ, θ and Δ are adjustable coefficients (example values are given in Setzmann et al.).

In a preferred embodiment, the second step comprises a second model describing an equilibrium adsorption capacity of the at least one gas adsorbent medium for the gas stored in the sorption store in dependency of at least the amount of gas present in the gas phase and wherein the first step optionally comprises a third model describing adsorption kinetics, said adsorption kinetics describing an adsorption rate in dependency of an adsorption capacity of the at least one gas adsorbent medium.

Based on the amount of gas present in the gas phase obtained in the first step, the amount of gas adsorbed by the at least one gas adsorbent medium is computed in a second step by means of a second model. In a preferred embodiment, the second model describes an equilibrium adsorption capacity of the at least one gas adsorbent medium for the gas stored in the sorption store in dependency of the gas concentration or amount of gas in the gas phase surrounding the gas adsorbent medium. The adsorption equilibrium is often described by adsorption isotherms describing the equilibrium adsorption capacity, defined by the ratio of the mass of the adsorbed gas to the mass of the adsorbent medium, in function of the pressure, the partial pressure or the concentration of the gas in the gas phase.

In a preferred embodiment, the second model is based on an adsorption mechanism of micropore filling or based on an adsorption mechanism of a layering process.

In a further preferred embodiment, the second model is based on the adsorption mechanism of micropore filling or on the adsorption mechanism of layering processes. The micropore filling mechanism is commonly assumed for process, in which molecules are adsorbed in the adsorption space within micropores. In turn, layering processes can be divided into the monolayer adsorption and the multilayer adsorption. In monolayer adsorption, all adsorbed molecules are in contact with the surface of the adsorbent medium. In multilayer adsorption, more than one layer of molecules are present on the surface of the adsorbent medium and therefore, not all adsorbed molecules are in direct contact with the surface of the adsorbent medium but rather adsorbed or condensed on molecule layers already covering the surface of the adsorbent medium.

In a particularly preferred embodiment, the second model comprises a Dubinin-Astakhov equation.

In a particularly preferred embodiment, the second model is based on the micropore filling adsorption mechanism and comprises the Dubinin-Astakhov equation:

$${n}_{a} = {n}_{max} * exp [ - {( \frac{A}{E} )}^{w} ]$$

or modifications thereof, where nₐ is the adsorbed amount of gas per unit adsorbent medium, nₘₐₓ is the limit amount of adsorbed gas, A is the adsorption energy, E is the eigenvalue of the adsorption energy and the exponent w is related to the porous structure of the adsorbent medium. The adsorption energy can be expressed as

A=R*T*In (p₀/p),

where R is the ideal gas constant, T is the temperature, p is the pressure and p₀ is the saturation pressure of the vapor at temperature T. Further, the eigenvalue of the adsorption energy can be described as

E=k+j*T,

where k and j are the enthalpy factor and the entropy factor, respectively.

For example, for most activated carbons the exponent w is set to 2. A is the adsorption energy or adsorption potential, also called the deferential molar work of adsorption, which represents the negative differential Gibbs free energy. Typically, k is approximatly the adsorption enthalpy with 1 kJ/mol to 100 kJ/mol, w is assumed to be between 1 and 4 and j is assumed to be between 0.001 and 1. The Dubinin-Astakhof equation is especially preferred for applications involving MOFs, as the parameter fitting leads to improved results.

In a further preferred embodiment, the second model is based on the Toth equation describing the adsorption equilibrium. The Toth equation is known for its simple form and its correct thermodynamic consistency at low and high pressures. The Toth equation can be written as

$$N = \frac{{N}_{s} * x * P}{{[ 1 + {( x * P )}^{m} ]}^{1 / m} ]} ,$$

wherein N is the adsorption capacity, Nₛ is the monolayer capacity, x is related to the adsorption affinity at low pressure, and m characterizes the system heterogeneity. The more the parameter m deviates from unity, the more heterogeneous is the system. For m=1, the Toth equation reduces to the Langmuir equation.

In addition to the Dubinin-Astakhov equation, the Toth equation and modifications thereof, all other models describing the adsorption equilibrium or adsorption isotherms can also be implemented in the second model. Examples for further suitable models are the linear isotherm, the Freundlich isotherm or the BET model.

In a further preferred embodiment, the second model comprises a term describing the adsorption kinetics, for example as a third model. This is in particular important for the indication of the fill level during the filling procedure, wherein the variation of the amount of adsorbed gas with time is enhanced. Here, equilibrium conditions are not always reached in the system. Therefore, the adorption kinetics play a role for an exact calculation of the adsorbed amount of gas and the total amount of gas present in the sorption store. To give an example, the linear driving force (LDF) model can be used to describe the kinetics as disclosed by Xiao et al. for the cryo adsorption of hydrogen. Any other descriptions of the adsorption kinetics are also suitable.

Methods for the determination of the adsorption kinetics are known by a person skilled in the art. The adsorption kinetics are determined for example with the help of pressure jump experiments or adsorptions balances (see “Zhao, Li and Lin, Industrial and Engineering Chemistry Research, 48 (22) 2009, pages 10015 to 10020”). The adsorption kinetic describes the course of the adsorption of a gas on an adsorbent medium with the time at isothermic and isobar conditions.

As the adsorption kinetic can often be approximated by an exponentially decaying function, which shows a steep slope in the beginning and which flattens until a convergence to the end value. An example for such an approximation is the function a·(1−e^{-bt}), whereas a and b are positive constants. The adsorption kinetic can equally be approximated by other functions as for example by a concave function, a function which is constant in certain sections, and a function which is linear in certain sections or a linear function which bonds the initial and the end value.

The amount of gas adsorbed on the at least one adsorbent medium strongly depends on temperature. A detailed representation of the temperature distribution in the interior of the sorption store can be simulated for example by means of computational fluid dynamics (CFD). In a preferred embodiment the isosteric heat of adsorption is taken into consideration and can be expressed by the Clausius-Clapeyron equation as disclosed by Mu et al. The isosteric heat of adsorption can be assumed to be constant for the purpose of the second model or, in a further preferred embodiment, the variation of the isosteric heat of adsorption can be considered as for example disclosed by Xiao et al. The accuracy of the indication of the fill level can be enhanced when the variation of the heat of adsorption with the amount of adsorbed gas is taken into consideration, i.e. as the mass of adsorbed gas is small in the initial stage of the filling process. The function describing the variation of the isosteric heat of adsorption can be complex, especially in case of heterogeneous adsorbents.

In a preferred embodiment, heat capacities present in the vessel of the sorption store can be described in detail for the purpose of the indication of the fill level. For example an effect of the heat capacity of the adsorbed gas on the effective heat capacity can be taken into consideration.

In a further preferred embodiment, the second model comprises the mass conservation equation, the momentum conservation equation and the energy conservation equation. Examples are given in Xiao et al. The mass conservation equation relates the mass transferred from the gas phase to the adsorbed phase per unit volume and per second to the porosity of the adsorbent medium and the adsorption rate. The momentum conservation equation takes the viscosity into consideration. The energy conservation equation balances the amount of energy accumulated in the sorption store and the energy variations due to convective flow, pressure work, conductive and thermal dispersion fluxes as well as heat released due to the adsorption process.

Further information on the recited models and theories can be found in Xiao et al. and Mu et al. and in the references cited there, as well as in thermodynamic and adsorption handbooks.

Any software, preferably Matlab/Simulink or Comsol can be applied for the computation of the described models.

In a preferred embodiment, at least one temperature sensor measuring the at least one measured temperature value and at least one pressure sensor measuring the at least one measured pressure value are disposed in the at least one vessel and/or at the inlet of the sorption store.

In a preferred embodiment, the data obtained by the at least one pressure sensor and the at least one temperature sensor are collected and computed by a control unit, in particular by the engine control unit of a vehicle., The output value, namely the fill level, is transmitted to an operator or driver in the driver's cabin of the vehicle, for example, or to another unit for further control or regulation. In a further preferred embodiment, a display indicating the fill level of the sorption store is located in the driver's cabin as known for common fuel indicators.

In a preferred embodiment the specific configuration of a control unit effectuating the indication of a fill level of a sorption store is based on specific parameters regarding the vessel, the adsorbent medium and the gas to be stored. The specific parameters are namely the mass of the vessel with and without adsorbent medium, the molar mass of the gas, the saturated vapor pressure of the gas, the inner radius of the vessel, the external radius of the vessel, the length of the vessel, the density of the adsorbent medium, the specific heat capacity of the adsorbent medium, the thermal conductivity of the adsorbent medium, the porosity of the adsorbent medium, the density of the gas, the specific heat capacity of the gas, the thermal conductivity of the gas, the viscosity of the gas, the viscosity resistance coefficient of the gas, the density of the vessel material, the specific heat capacity of the vessel material and the thermal conductivity of the vessel material to give some examples.

In an embodiment of the invention the stored gas contains hydrocarbons and/or water, and combinations thereof. The stored gas contains preferably gas selected from a group comprising of methane, ethane, butane, hydrogen, propane, propene, ethylene, water and/or methane, and combinations thereof, in particular natural gas. In particular preferred is stored gas which comprises methane as a main component.

Fuels can be stored in the sorption store of the invention and be provided by desorption to an internal combustion engine or a fuel cell for example. Methane is particularly suitable as fuel for internal combustion engines. Fuel cells are preferably operated using methanol or hydrogen.

In a preferred embodiment of the invention the gas adsorbent medium is a porous and/or microporous solid.

In a particularly preferred embodiment, the at least one gas adsorbent medium is selected from a group comprising activated charcoals, zeolites, activated alumina, silica gels, open-pore polymer foams and metal-organic frameworks, and combinations thereof.

Various materials are suitable as adsorbent medium for the sorption store. The adsorbent medium preferably comprises activated charcoals, zeolites, activated alumina, silica gels, open-pore polymer foams and metal-organic frameworks (MOFs). The adsorption medium preferably comprises metal-organic frameworks (MOFs).

Zeolites are crystalline aluminosilicates having a microporous framework structure made up of AlO₄ and SiO₄ tetrahedra. Here, the aluminum and silicon atoms are joined to one another via oxygen atoms. Possible zeolites are zeolite A, zeolite Y, zeolite L, zeolite X, mordenite, ZSM (Zeolites Socony Mobil) 5 or ZSM 11. Suitable activated carbons are in, particular, those having a specific surface area above 500 m² g⁻¹, preferably about 1500 m² g⁻¹, very particularly preferably above 3000 m² g⁻¹. Such an activated carbon can be obtained, for example under the name Energy to Carbon or MaxSorb.

Metal-organic frameworks (MOF) are known in the prior art and are described for example in U.S. Pat. No. 5,648,508, EP-A 0 700 253, M. O'Keeffe et al., J. Sol. State Chem., 152 (2000), pages 3 to 20, H. Li et al., Nature 402, 1(1999), page 276, M. Eddaoudi et al., Topics in Catalysis 9, (1999), pages 105 to 111, B. Chen et al., Science 291, (2001), pages 1021 to 1023, DE-A 101 11 230, DE-A 10 2005 053430, WO-A 2007/054581, WO-A 2005/049892 and WO-A 2007/023134. The metal-organic frameworks (MOF) mentioned in EP-A 2 230 288 A2 are particularly suitable for sorption stores. Preferred metal-organic frameworks (MOF) are MIL-53, Zn-tBu-isophthalic acid, Al-BDC, MOF 5, MOF-177, MOF-505, MOF-A520, HKSUST-1, IRMOF-8, IRMOF-11, Cu-BTC, Al-NDC, Al-AminoBDC, Cu-BDC-TEDA, Zn-BDC-TEDA, Al-BTC, Cu-BTC, Al-NDC, Mg-NDC, Al-fumarate, Zn-2-methylimidazolate, Zn-2-aminoimidazolate, Cu-biphenyldicarboxylate-TEDA, MOF-74, Cu-BPP, Sc-terephthalate. Greater preference is given to MOF-177, MOF-A520, KHUST-1, Sc-terephthalate, Al-BDC and Al-BTC.

Apart from the conventional method of preparing the MOFs, as described, for example, in U.S. Pat. No. 5,648,508, these can also be prepared by an electrochemical route. In this regard, reference may be made to DE-A 103 55 087 and WO-A 2005/049892. The metal organic frameworks prepared in this way have particularly good properties in respect of the adsorption and desorption of chemical substances, in particular gases.

Particularly suitable materials for the adsorption in sorption stores are the metal-organic framework materials MOF A520, MOF Z377 and MOF C300.

MOF A 520 is based on aluminium fumarate. The specific surface area of a MOF A520, measured by porosimetry or nitrogen adsorption, is typically in the range from 800 m̂2/g to 2000 m̂2/g. The adsorption enthalpy of MOF A520 with regard to natural gas amounts to 17 kJ/mol. Further information on this type of MOF may be found in “Metal-Organic Frameworks, Wiley-VCH Verlag, David Farrusseng, 2011”. The pellets have all a cylindrical shape with a length of 3 mm and diameter of 3 mm. Their permeability is preferably between 1·10̂-15 m̂2 and 3·10̂-3 m̂2. The porosity of the bed, which is defined as the ratio of the void volume between the pellets to the total volume of the vessel without considering the free volume within the pellets, is at least 0.2, for example 0.35.

MOF Z377, in literature also referred to as MOF type 177, is based on zinc-benzene-tribenzoate. The specific surface area of a MOF Z377, measured by porosimetry or nitrogen adsorption, is typically in the range from 2000 m̂2/g to 5000 m̂2/g. The MOF Z377 typically posses an adsorption enthalpy between 12 kJ/mol and 17 kJ/mol with respect to natural gas. MOF C300 is based on copper benzene-1,3,5-tricarboxylate and for example commercially available from Sigma Aldrich under the tradename Basolite® C300.

Generally, a variety of materials can be applied and be combined for gas adsorbent media, independently of their characteristics regarding their impact on the gas flow in the vessel, their packing density and their heat capacity. The adsorbent media are preferably applied as pellets but can likewise be applied as powder, monolith or in any other form.

The porosity of the adsorbent medium is preferably at least 0.2. The porosity is defined here as the ratio of hollow space volume to total volume of any subvolume in the vessel for of the sorption store. At a lower porosity, the pressure drop on flowing through the adsorbent medium increases, which has an adverse effect on the filling time, i.e. prolongs the filling time.

In a preferred embodiment of the invention, the adsorbent medium is present as a bed of pellets and the ration of the permeability of the pellets to the smallest pellet diameter is at least between 1*ê-11 m̂2/m and 1*ê-16 m̂2/m, preferably between 1*ê-12 m̂2/m and 1*ê-14 m̂2/m, and most preferably 1*ê-13 m̂2/m. The rate at which the gas penetrates into the pellets during filling depends on the rapidity with which the pressure in the interior of the pellets becomes the same as the ambient pressure. With decreasing permeability and increasing diameter of the pellets, the time for this pressure equalization and, thus, also the loading time of the pellets increases. This can have a limiting effect on the overall process of filling and discharging a sorption store.

The sorption store for storing the gaseous fuel can comprise a closed vessel. When gas is taken from the store, rapid and constant provision of gas has to be ensured. The sorption store can be equipped with a feed device which comprises at least one passage through the vessel wall through which a gas can flow into the vessel. The feed device can comprise, for example, an inlet and an outlet which can each be closed by means of a shutoff device.

The feed device can comprise means to vary the gas stream for example throttle valves or control valves, which can be located inside or outside of the vessel. The vessel can further comprise more than one passage through the vessel wall for example in order to lead the gas stream in optional subdepartments of the vessel or in order to provide separate passages for the filling and the discharge of the gas. Preferably, the same passage or the same passages are used for both, the discharge of the gas and the filling of the vessel.

Depending on the installation space available and the maximum permissible pressure in the vessel, different cross-sectional areas are suitable for the cylindrical vessel, for example circular, elliptical or rectangular. Irregularly shaped cross-sectional areas are also possible, e.g. when the vessel is to be fitted into a hollow space of a vehicle body. For high pressures above about 100 bar, circular and elliptical cross sections are particularly suitable. The vessel size vary according to the application. Diameters of the vessel of approximately 50 cm are typical for tanks in trucks and approximately 20 cm for tanks in cars, respectively. In cars fill volumes between 20 L and 40 L are provided whereas tanks of a volume between 500 L and 3000 L can be found in trucks.

In a further embodiment, the at least one vessel is substantially mounted horizontally. The vessel can be characterized by an elongated form and it can be installed in a horizontal position. Besides a vessel substantially horizontally mounted vessel, a vertical installation is likewise feasible. In a further embodiment, the vessel of the sorption store has a cylindrical shape and optionally a dividing element is arranged essentially coaxially to the cylinder axis.

The choice of the wall thickness of the vessel and of the dividing elements is dependent on the maximum pressure to be expected in the vessel, the dimensions of the vessel, in particular its diameter, and the properties of the material used. Materials for a vessel of sorption store are variable. Preferred materials are for example steel. In the case of an alloy steel vessel having an external diameter of 10 cm and a maximum pressure of 100 bar, for example, the minimum wall thickness has been estimated as 2 mm (in accordance with DIN 17458). The gap width of the double walls is selected so that a sufficiently large volume flow of the refrigerant can flow through them. It is preferably from 2 mm to 10 mm, particularly preferably from 3 mm to 6 mm.

In an embodiment of the invention, the at least one vessel is a pressure vessel for the storage of gas at a pressure in the range up to 500 bar, preferably in a range of 1 bar to 400 bar, most preferably in a range of 1 bar to 250 bar and in particular preferably in a range of 1 bar to 100 bar.

In a preferred embodiment, the gas is stored under pressure up to 500 bar, preferably in a range of 1 bar to 400 bar, most preferably in a range of 1 bar to 250 bar and in particular preferably in a range of 1 bar to 100 bar.

In a preferred embodiment of the invention the maximum adsorption capacity of the gas adsorbent medium is reached at a pressure of less than 250 bar, in particular at a pressure of less than 200 bar.

The vessel is usually cooled during filling and/or heated during discharging. As a result, larger amounts of gas can be adsorbed or desorbed in the same time.

An improvement in heat transfer can be achieved when not only the vessel wall but also optional at least one dividing element, or in the case of a plurality of dividing elements one or more thereof, are cooled or heated. For this purpose, the at least one dividing element or a plurality of dividing elements, in particular all dividing elements present, can be configured as double walls so that a refrigerant can flow through them.

A configuration with double-walled channel walls has the advantage that for switching from cooling to heating, it is merely necessary for the coolant to be changed or its temperature to be altered appropriately. Thus, this embodiment is, in mobile use, equally suitable for filling with fuel and for the traveling mode. A pump can convey the refrigerant in the cooling circuit. A pumping power of the pump can be varied as a function of a fill level of the sorption store.

Depending on the temperature range, which is appropriate for the cooling or heating of the gas in the sorption store, different heat carrier media may apply, for example water, glycol, alcohols or mixtures thereof. Corresponding heat carrier media are known by a person skilled in the art.

The time required for filling the sorption store is essentially determined by the material properties of the adsorbent medium, in particular by its adsorption kinetics. Another impact factor is the maximum temperature which is reached during filling, which equally depends on the material properties, in particular on the adsorption enthalpy.

In a preferred embodiment of the invention the temperature of the gas is measured in at least one point inside of the vessel. The fed amount of gas is adapted; if necessary, to this measured value in order to respect a given maximum temperature.

The present invention also discloses a sorption store, i.e. an ANG-storage reservoir which contains at least one adsorbent medium, such as metal-organic framework (MOF) and which is equipped with a control unit for effectuating the process according to the invention. The invention further includes a vehicle comprising a sorption store with a device for effectuating the process according to the invention, wherein the current fill level of the sorption store is displayed in the driver's cabin as an absolute value or as a proportion of a maximum amount of gas storable in the sorption store. The invention further discloses a vehicle comprising an engine control unit effectuating the process according to the invention.

### BRIEF DESCRIPTION OF THE DRAWINGS

The present invention is described in more detail at hand of the accompanying drawings, in which:

FIG. 1 shows a sorption store according to the invention;

FIG. 2 shows particles of an adsorbent medium according to the invention;

FIG. 3 shows the pressure and temperature course during filling the sorption store;

FIG. 4.1 shows the temperature variation in the sorption store;

FIG. 4.2 shows examples for positions of temperature sensors in the sorption store;

FIG. 5 shows the measured and simulated gas density in the sorption store;

FIG. 6 shows a vehicle comprising a control unit according to the invention;

FIG. 7 shows a scheme of the process according to the invention.

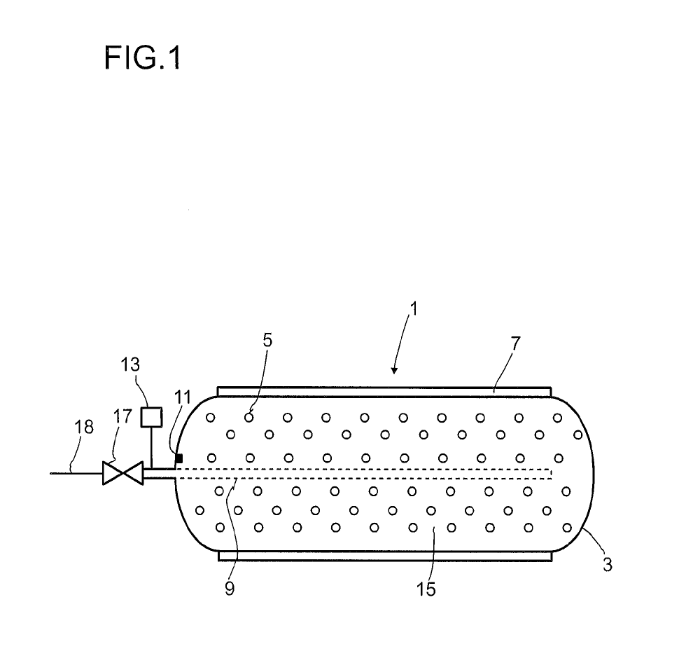

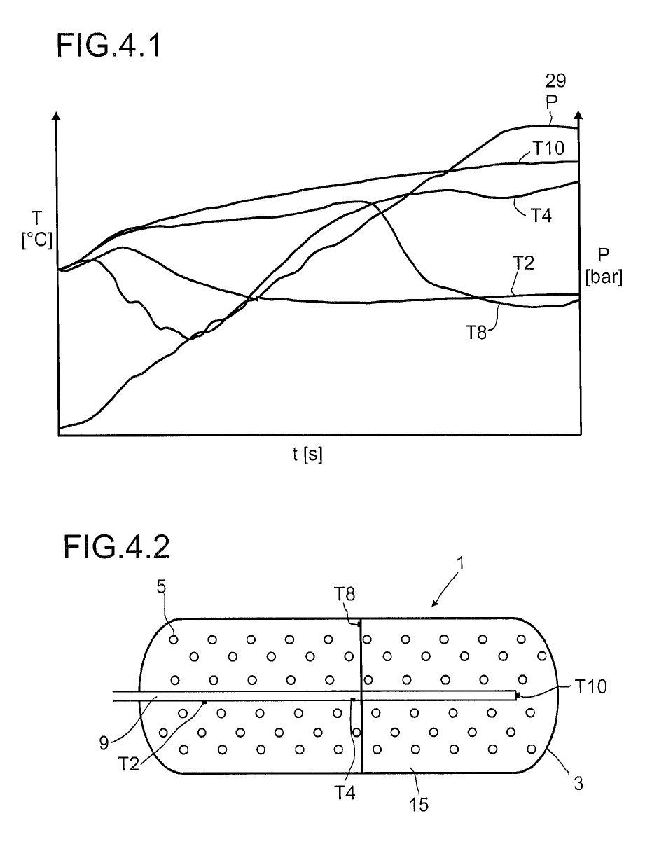

FIG. 1 shows a sorption store 1 according to the invention, which comprises a vessel 3, wherein at least one adsorbent medium 5 is disposed. The outer wall of the vessel 3 can be embodied as a double jacket 7 serving for cooling and heating the sorption store 1 during filling and discharging, respectively. The at least one adsorbent medium 5 is surrounded by a gas 15, which is fed into the sorption store 1 through a supply pipe 18 and an inlet valve 17. The sorption store 1 is equipped with at least one temperature sensor 11 and at least one pressure sensor 13 and optionally with an internal inlet pipe 9. The gas 15 enters the vessel 3 directly at the inlet or alternatively through the internal inlet pipe 9. The at least one temperature sensor 11 and the at least one pressure sensor 13 can be disposed in the at least one vessel 3 and/or at the inlet of the sorption store 1 and/or in the supply pipe 18 to the sorption store 1. Further examples for positions of the at least one temperature sensor 11 and the at least one pressure sensor 13 are given in FIG. 4.2. From the at least one temperature sensor 11 and the at least one pressure sensor 13, an at least one measured temperature value and an at least one measured pressure value is obtained in order to compute a total amount of gas 15 stored in the sorption store 1 for the indication of a fill level.

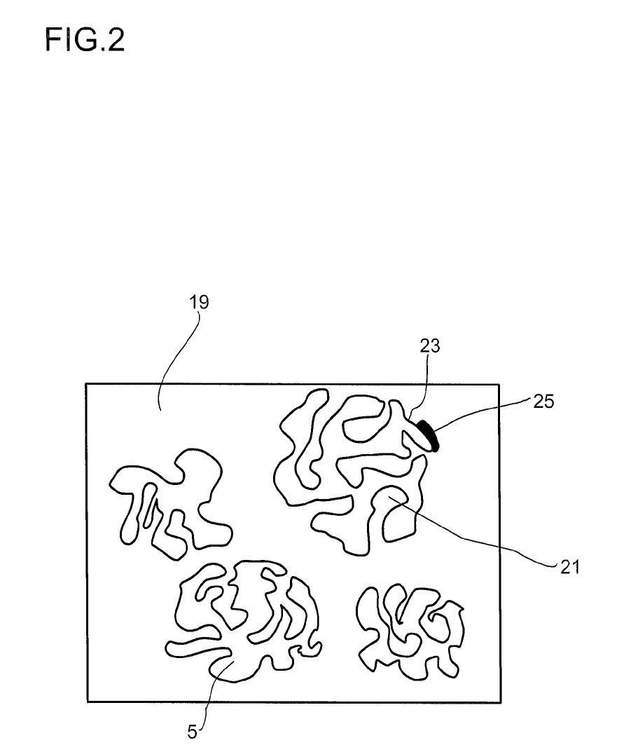

FIG. 2 shows a section of the interior of the sorption store 1, where particles of the adsorbent medium 5 are surrounded by a gas phase 19. The particles of the adsorbent medium 5 possess a certain porosity resulting in inner pores 21 and a free volume inside the particles of the adsorbent medium 5. Due to the porosity, the adsorbent medium possesses a large specific surface 23 on which an adsorbed phase 25 is formed by the gas 15 adsorbed by the at least one gas adsorbent medium 5. The total amount of gas 15 stored in the sorption store 1 is the sum of the amount of gas 15 present in the gas phase 19 and the amount of gas 15 present in the adsorbed phase 25. The gas phase 19 includes the free volume surrounding the particles of the adsorbent medium 5 as well as the free volume in the inner pores 21 of the particles of the adsorbent medium 5. A density of the stored gas 15 is obtained by dividing the total amount of gas 15 stored in the sorption store 1, i.e. the amount of gas present in the gas phase 19 and the amount of gas 15 present in the adsorbed phase 25, by the total volume of the interior of the sorption store 1.

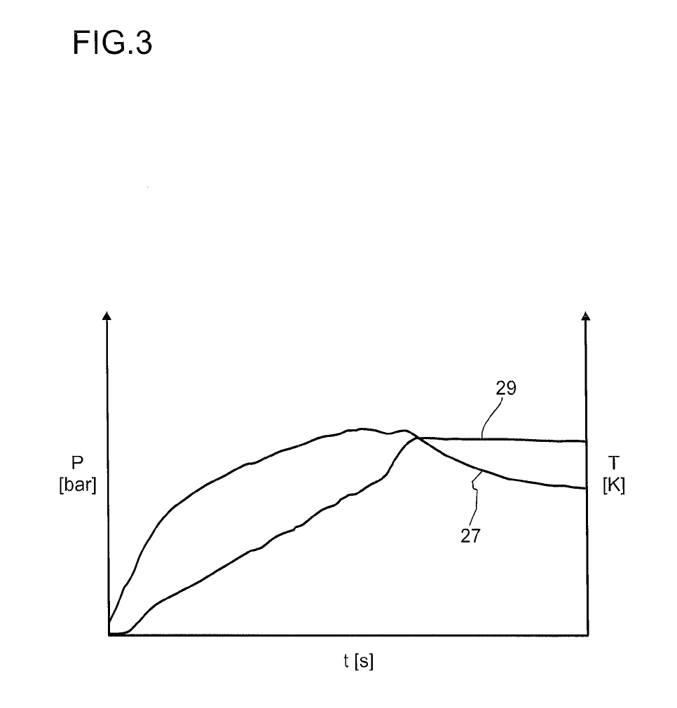

FIG. 3 shows the temperature course 27 and the pressure course 29 in the sorption store 1 as a function of time during the filling process. The pressure increases in the vessel due to the increasing amount of gas 15 stored in the sorption store 1. During the filling process, heat is liberated by the compression of the gas 15 and by the adsorption of the gas 15 on the specific surface 23 of the adsorbent medium 5. Consequently, the temperature increases with increasing pressure and the temperature declines once the filling process is accomplished. Once the filling process is accomplished and the inlet valve 17 is closed, the total amount of gas 15 stored in the sorption store 1 is constant until the parts of the gas 15 are discharged again and the temperature course 27 is declining. Even so the total amount of gas 15 is constant, it is possible the amount of gas 15 present in the gas phase 19 and the amount of gas present in the adsorbed phase 25 is still changing until a homogeneous temperature distribution and an adsorption equilibrium is reached. In case of discharging the sorption store 1 firstly the amount of gas 15 present in the gas phase 19 is reduced and consequently the amount of gas 15 present in the adsorbed phase 25 is reduced, as gas 15 is desorbs and the adsorption equilibrium is reestablished at a lower level.

FIG. 4.1 shows the spatial temperature distribution in the sorption store 1 changing with time. According to FIG. 4.2 the vessel 3 comprises an internal inlet pipe 9, an adsorbent medium 5 is disposed in the vessel 3 and the sorption store 1 is filled with gas 15. The temperature is measured in the positions T2, T4, T8 and T10 and the corresponding temperature courses are represented as a function of time in FIG. 4.1. Further, the pressure course 29 is given. It can be seen from FIGS. 4.1 and 4.2 that the temperature distribution is heterogeneous with regard to the different positions T2, T4, T8 and T10 in the sorption store 1. During filling the sorption store 1, the local temperature in the interior of the sorption store 1 strongly depends on the position of the specific temperature sensor.

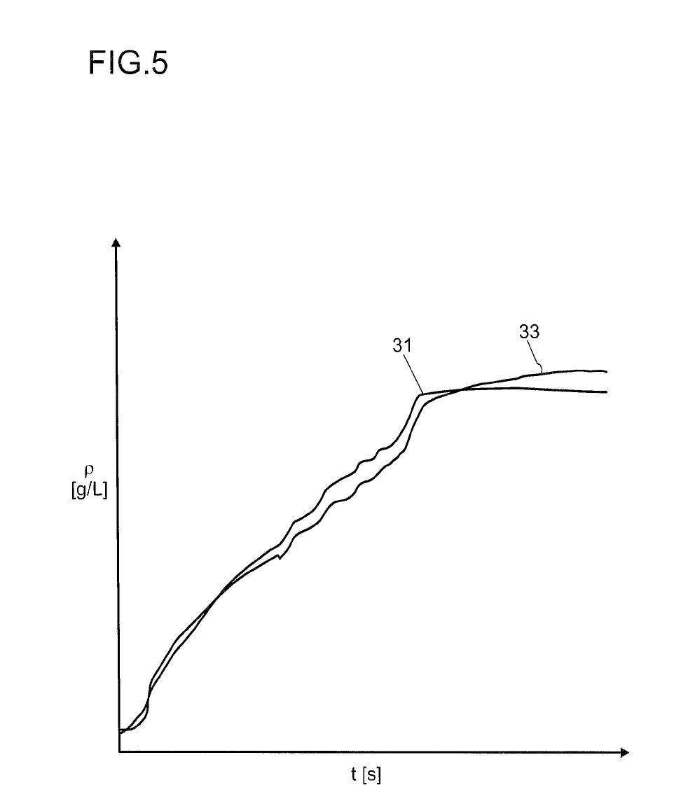

FIG. 5 shows the density of the stored gas 15 as a function of time. Graph 31 represents the measured density of the stored gas 15, whereas graph 33 represents the simulated density of the gas 15 obtained by a process according to the invention. In both graphs, the gas density increases with the progress of the filling process. The course of the two graphs is narrow, i.e. the process according to the invention is suitable for the simulation and the quantification of the total amount of gas 15 stored in the sorption store 1.

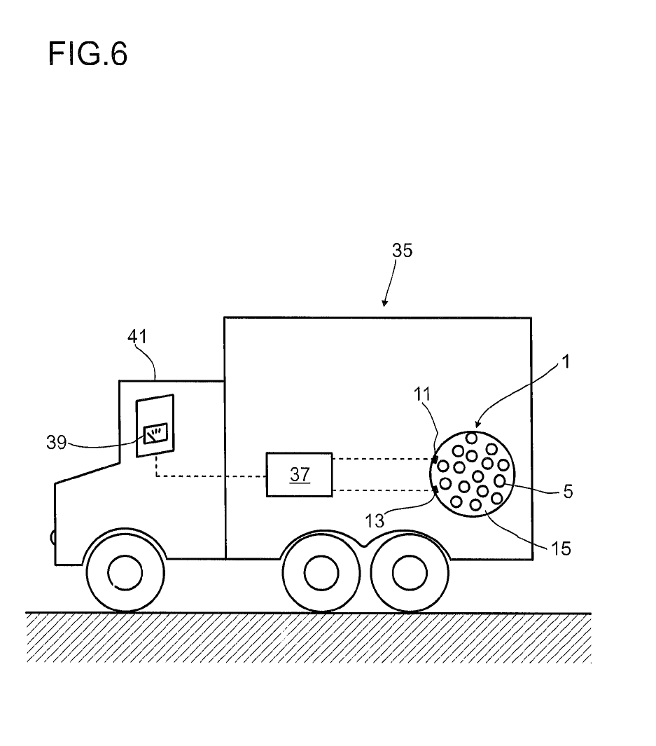

FIG. 6 shows a vehicle 35 comprising a sorption store 1 according to the invention, which contains an adsorbent medium 5 and a gas 15 and which is equipped with a temperature sensor 11 and a pressure sensor 13. The measured temperature values and the measured pressure values are transferred to a control unit 37, where a process according to the invention is effectuated and the output value of the total amount of gas 15 stored in the sorption store 1 is transferred to a display 39 in the driver's cabin 41, where the fill level of the sorption store 1 is indicated.

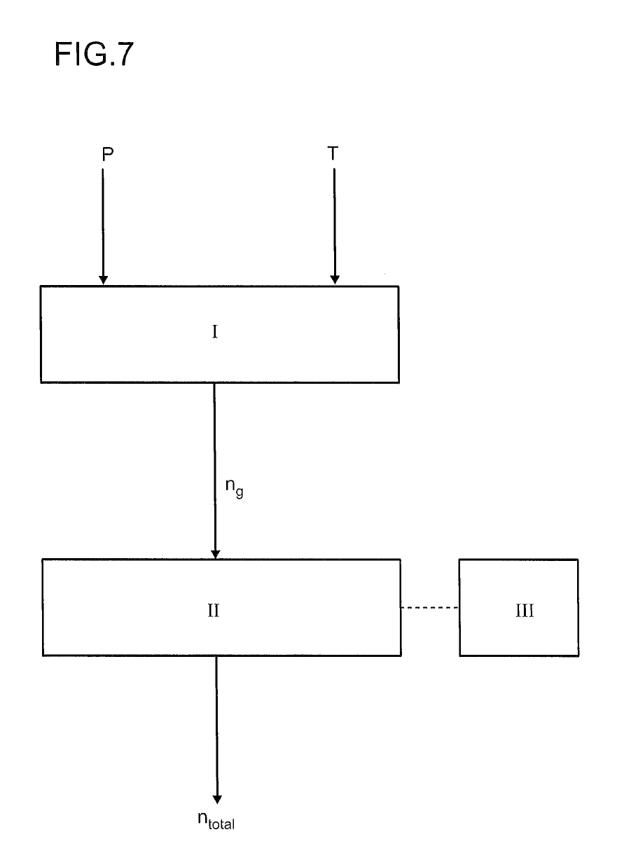

FIG. 7 shows a process scheme according to the invention, wherein in a first step, a first model I is applied to compute an amount n_{g} of gas 15 present in the gas phase 19 from at least one measured temperature value T and at least one pressure value P. The computed amount n_{g} is the input value for the second model II, wherein in a second step, a total amount nₜₒₜₐₗ of gas 15 stored in the sorption store 1 is computed based on the adsorption equilibrium and optionally on the adsorption kinetics in a third sub-model III.

### COMPARATIVE EXAMPLE

A horizontally mounted sorption store with an inner volume of 534 liter is filled with natural gas up to a pressure of 250 bar. The metal-organic framework material A 520 is disposed in the sorption store as gas adsorbent medium. A temperature sensor is located at the end of an internal inlet pipe in the vessel and a pressure sensor is positioned at the inlet of the sorption store. The tank is filled according to the conventional compressed natural gas (CNG) technique, for example described in US 2005/0178463. The pressure is increased from 1 to 250 bar within 3 minutes. Then the inlet valve is closed. The pressure and the temperature course is monitored and represented as for example shown in FIG. 3. Further, the mass of the gas currently stored in the sorption store is determined gravimetrically during the filling process. The gas density is obtained by dividing the gas mass in the sorption store before and after the filling by the inner volume of the sorption store. The measured density of the stored gas is represented as shown for example in FIG. 5 as graph 31.

### EXAMPLE

The filling procedure of the comparative example is repeated and the measured temperature and pressure is used to compute the density of the stored gas by a process according to the invention. Therefore, the amount of gas present in the gas phase surrounding the particles of the adsorbent medium is computed in a first step. In a second step, the amount of gas adsorbed by the at least one gas adsorbent medium is calculated by a second model based on the Dubinin-Astakhov equation. The sum of the amount of gas present in the gas phase and the amount of gas adsorbed by the at least one gas adsorbent medium equals to the total amount of gas stored in the sorption store. The simulated gas density is obtained by dividing the computed total mass of gas in the sorption store by the inner volume of the sorption store. The simulated gas density is represented as shown for example in FIG. 5 as graph 33.

### LIST OF REFERENCE NUMERALS

1 Sorption store

3 Vessel

5 Adsorbent medium

7 Double jacket

9 Internal inlet pipe

11 Temperature sensor

13 Pressure sensor

15 Gas

17 Inlet valve

18 Supply pipe

19 Gas phase

21 Inner pores

23 Specific surface

25 Adsorbed phase

27 Temperature course

29 Pressure course

31 Measured density

33 Simulated density

35 Vehicle

37 Control unit

39 Display

41 Driver's cabin

I First model

II Second model

III Third model

P Pressure

T Temperature

n_{g} Amount of gas 15 present in the gas phase 19

nₜₒₜₐₗ Total amount of gas 15 stored in the sorption store 1

1.-23. (canceled)

24. A process for indicating a fill level of a sorption store, wherein at least one gas adsorbent medium is disposed within at least one vessel and wherein a total amount (nₜₒₜₐₗ) of a gas stored in the sorption store is computed based on at least one measured temperature value and at least one measured pressure value.

25. The process according to claim 24, wherein the total amount (nₜₒₜₐₗ) of a gas stored in the sorption store is computed based on an empirical model defining the relation between the total amount of gas stored in the sorption store and the at least one measured temperature value and the at least one measured pressure value and wherein parameters of the empirical model are fitted to experimental data.

26. The process according to claim 24, comprising at least two steps, wherein an amount (n_{g}) of gas present in a gas phase is computed in a first step and an amount of gas adsorbed by the at least one gas adsorbent medium is computed in a second step and wherein the total amount (nₜₒₜₐₗ) of gas stored in the sorption store is the sum of the amounts of gas calculated in the at least two steps.

27. The process according to claim 26, wherein the first step comprises a first model (I) describing an amount (n_{g}) of gas present in a gas phase in dependency of the at least one measured temperature value and the at least one measured pressure value.

28. The process according to claim 27, wherein the first model (I) comprises a thermodynamic equation of state based on the real gas behaviour of methane.

29. The process according to claim 27, wherein the first model (I) comprises a thermodynamic equation of state selected from the group consisting of the ideal gas law, the Van der Waals equation of state, the Redlich-Kwong equation of state, the Peng-Robinson equitation of state and modifications thereof.

30. The process according to claim 26, wherein the second step comprises a second model (II) describing an equilibrium adsorption capacity of the at least one gas adsorbent medium for the gas stored in the sorption store in dependency of at least the amount (n_{g}) of gas present in the gas phase and wherein the first step optionally comprises a third model (III) describing adsorption kinetics, said adsorption kinetics describing an adsorption rate in dependency of an adsorption capacity of the at least one gas adsorbent medium.

31. The process according to claim 30, wherein the second model (II) is based on an adsorption mechanism of micropore filling or based on an adsorption mechanism of a layering process.

32. The process according to claim 30, wherein the second model (II) comprises a Dubinin-Astakhov equation and/or a Langmuir equation.

33. The process according to claim 24, wherein the at least one gas adsorbent medium is a porous and/or microporous solid.

34. The process according to claim 24, wherein the at least one as adsorbent medium is present as a monolith or as a powder or as a bed of pellets and wherein the ratio of the permeability of the pellets to the smallest pellet diameter is between 1*e⁻¹¹ m²/m and 1*e⁻¹⁶ m²/m.

35. The process according to claim 24, wherein the at least one gas adsorbent medium is selected from the group consisting of activated charcoals, zeolites, activated alumina, silica gels, open-pore polymer foams, metal-organic frameworks, and combinations thereof.

36. The process according to claim 24, wherein the stored gas contains hydrocarbons and/or water.

37. The process according to claim 24, wherein the stored gas contains gas selected from the group consisting of methane, ethane, butane, hydrogen, propane, propene, ethylene, water, methane, and combinations thereof.

38. The process according to claim 24, wherein the stored gas comprises methane as a main component.

39. The process according to claim 24, wherein the gas is stored under pressure in the range of 1 bar to 400 bar.

40. A device for effectuating the process according to claim 24.

41. A sorption store comprising the device of claim 40.

42. The sorption store of claim 41, wherein at least one temperature sensor measuring the at least one measured temperature value and at least one pressure sensor measuring the at least one measured pressure value are disposed in the at least one vessel and/or at the inlet of the sorption store and/or in a supply pipe to the sorption store.

43. The sorption store of claim 42, wherein the at least one temperature sensor is disposed in the vessel in a position characterized by a temperature from Which the average temperature of the interior of the sorption store is deducable.

44. The sorption store of claim 42, wherein the at least one temperature sensor is disposed in the vessel in a position, which is in case of a substantially horizontally mounted vessel located centrally with regard to a vertical extension of the vessel and centrally or further away from an inlet with regard to a horizontal extension of the vessel and which is in case of a substantially vertically mounted vessel located centrally with regard to the horizontal extension of the vessel and centrally with regard to the vertical extension of the vessel.

45. A vehicle comprising the sorption store of claim 41.

46. A vehicle, comprising an engine control unit effectuating the process according to claim 24. 47, (New) The process according to claim 24, wherein the at least one gas adsorbent medium is present as a monolith or as a powder or as a bed of pellets and wherein the ratio of the permeability of the pellets to the smallest pellet diameter is between 1*ê-12 m̂2/m and 1*ê-14 m̂2/m.

48. The process according to claim 24, wherein the stored gas contains natural gas.

49. The process according to claim 24, wherein the gas is stored under pressure in the range of 1 bar to 250 bar.
